(19) United States
(12) Patent Application Publication
(10) Pub. No.: US 2016/0229260 A1
(43) Pub. Date: Aug. 11, 2016

(54) COOLING SYSTEM USING RANKINE CYCLE AND THERMOELECTRIC MODULE AND CONTROL METHOD THEREOF

(71) Applicant: Hyundai Motor Company, Seoul (KR)

(72) Inventors: Dong-Won PARK, Yongin-si (KR); Jin-Hee Cho, Suwon-si (KR)

(73) Assignee: Hyundai Motor Company, Seoul (KR)

(21) Appl. No.: 14/802,049

(22) Filed: Jul. 17, 2015

(30) Foreign Application Priority Data
Feb. 9, 2015 (KR) 10-2015-0019292

(51) Int. Cl. B60H 1/00; F24F 5/00

(52) U.S. Cl. CPC B60H 1/00271; F24F 5/0042; B60H 1/00478

(57) ABSTRACT

A cooling system using a Rankine cycle and a thermoelectric module may include a pressure pump sucking and compressing a working fluid and discharging it in a high-pressure liquid state, a heater heating the working fluid in the high-pressure liquid state discharged from the pressure pump and discharging it in a high-pressure vapor state, an expander expanding the working fluid in the high-pressure vapor state discharged from the heater to generate power and discharging the working fluid in a low-pressure vapor state, a condenser cooling the working fluid in the low-pressure vapor state discharged from the expander to be condensed in the low-pressure liquid state and discharging it in the low-pressure liquid state, and a thermoelectric module having a high-temperature unit installed on one surface thereof, a low-temperature unit installed on the other surface thereof, and a semiconductor embedded in a center thereof.

### CROSS-REFERENCE TO RELATED APPLICATION

The present application claims priority to Korean Patent Application No. 10-2015-0019292, filed on Feb. 9, 2015, the entire contents of which is incorporated herein for all purposes by this reference.

### BACKGROUND

1. Field of the Invention

Exemplary embodiments of the present invention relate to a cooling system using a Rankine cycle and a thermoelectric module and a control method thereof, and more particularly, to a cooling system using a Rankine cycle and a thermoelectric module and a control method thereof capable of using heat generated during cooling for power generation while performing cooling using the thermoelectric module.

2. Description of Related Art

Generally, air conditioning equipment which controls vehicle temperature is referred to as heating ventilating and air conditioning (HVAC) for short. The air conditioning equipment serves to control indoor air of a vehicle on the basis of a heating system which increases an indoor temperature of a vehicle and on the contrary, a cooling system which reduces the indoor temperature of the vehicle.

An air conditioner system in the cooling system of the vehicle is configured to largely include a compressor which compresses air conditioner gas, a condenser which condenses the compressed air conditioner gas, an evaporator, and the like. A typical air conditioner system of a vehicle is operated in the same principle as a general residential air conditioner. However, unlike the general residential air conditioner, the air conditioner system of the vehicle uses engine power (machine power) and obtains cooling power by operating an air conditioner compressor which is connected to an engine by a belt at the time of operating the air conditioner. Further, an electric vehicle drives the air conditioner compressor by rotating a motor using electric power instead of the engine power (machine power) to obtain the cooling power. However, the typical air conditioner system of the vehicle as described above consumes the separate machine power or electric power, and therefore has a problem of reduction in fuel efficiency. Further, a Freon-based gas refrigerant which is environmental pollutants is circulated inside a pipe, and therefore the environmental pollution is likely to occur due to the leakage of the gas refrigerant during the maintenance of the vehicle, and the like.

To solve the problem of the air conditioner system of the vehicle as described above, a cooling system using a thermoelectric module (TEM) has been developed. The thermoelectric module uses a mutual conversion phenomenon of heat and electricity, that is, a change in temperature of electric resistance and is a device using a phenomenon (Seebeck effect) of generating an electromotive force due to a temperature difference, a device (Peltier device) using a phenomenon (Peltier effect) of absorbing or generating heat in response to a current, etc.

The Seebeck effect is a phenomenon of generating an electromotive force when both ends of two kinds of metals are connected to each other and are set to be different temperatures and the Seebeck device is a thermocouple and is used to measure temperature. The Peltier effect is a phenomenon of absorbing heat into one end and generating heat from the other end depending on a current direction when both terminals of two kinds of metals are connected to each other and a current flows in both terminals.

The cooling system of the vehicle using the thermoelectric module as described above has a simpler structure than that of the existing air conditioner system of the vehicle, thereby reducing a system weight. Further, the cooling system of the vehicle using the thermoelectric module has an advantage in that it need not use the gas refrigerant but has a problem in that it has the reduced cooling efficiency.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a cooling system in which a Rankine cycle system generating energy and power using heat energy and a cooling system using a thermoelectric module are fused and a control method thereof.

Other objects and advantages of the present invention can be understood by the following description, and become apparent with reference to the exemplary embodiments of the present invention. Also, it is obvious to those skilled in the art to which the present invention pertains that the objects and advantages of the present invention can be realized by the means as claimed and combinations thereof.

In accordance with an exemplary embodiment of the present invention, a cooling system using a Rankine cycle and a thermoelectric module includes: a pressure pump configured to suck and compress a working fluid inside the Rankine cycle and discharge the compressed working fluid in a high-pressure liquid state; a heater configured to heat the working fluid in the high-pressure liquid state discharged from the pressure pump and discharge the heated working fluid in a high-pressure vapor state; an expander configured to expand the working fluid in the high-pressure vapor state discharged from the heater to generate power and discharge the working fluid in a low-pressure vapor state; a condenser configured to cool the working fluid in the low-pressure vapor state discharged from the expander to be condensed in the low-pressure liquid state and discharge the condensed working fluid in the low-pressure liquid state; and a thermoelectric module configured to have a high-temperature unit installed on one surface thereof, a low-temperature unit installed on the other surface thereof, and a semiconductor embedded in a center thereof.

The thermoelectric module may be disposed between the pressure pump and the heater to heat the working fluid in the high-pressure liquid state using the high-temperature unit when being applied with a current.

The heater may include: a boiler configured to use heated engine cooling water to heat the working fluid; and a superheater configured to use heat from engine exhaust gas to heat the working fluid.

The cooling system of claim may further include: a heat exchanger configured to be connected to the low temperature unit of the thermoelectric module through a heat medium channel.

The cooling system may further include: a generator configured to convert power generated from the expander into a current.

The cooling system may further include: a battery configured to store a current generated from the generator and supply the current to the thermoelectric module.

The cooling system may further include: a current controller configured to be connected to the battery to control the current supplied to the thermoelectric module.

The cooling system may further include: controller configured to compare an indoor temperature measured by a measurer measuring the indoor temperature with a cooling setting temperature sensed by a sensor sensing the cooling setting temperature to control the current controller.

In accordance with another embodiment of the present invention, a control method of a cooling system using a Rankine cycle and a thermoelectric module includes: measuring an indoor temperature and sensing a cooling setting temperature (S100); comparing the measured indoor temperature with the sensed cooling setting temperature (S200); cooling an interior by controlling a current supplied to a thermoelectric module (S300); and generating the current supplied to the thermoelectric module through the Rankine cycle (S400).

The comparing (S200) may include: a first determining step (S210) of determining whether the measured indoor temperature exceeds the sensed cooling setting temperature: and a second determining step (S220) of determining whether the measured indoor temperature is less than the sensed cooling setting temperature if it is determined that the measured indoor temperature does not exceed the sensed cooling setting temperature.

The cooling (S300) may include: a first cooling step (S310) of increasing the current supplied to the thermoelectric module to reduce a temperature of a low temperature unit of the thermoelectric module if it is determined that the indoor temperature measured in the first determining step (S210) exceeds the sensed cooling setting temperature; a second cooling step (S320) of reducing the current supplied to the thermoelectric module to increase the temperature of the low temperature unit of the thermoelectric module if it is determined that the indoor temperature measured in the second determining step (S220) is less than the sensed cooling setting temperature; and a third cooling step (S330) of keeping the current supplied to the thermoelectric module to keep the temperature of the low temperature unit of the thermoelectric module if it is determined that the indoor temperature measured in the second determining step (S220) is not less than the sensed cooling setting temperature.

The generating (S400) may include: a compressing step (S410) of sucking and compressing a working fluid inside the Rankine cycle by a pressure pump and discharging the compressed working fluid in a high-pressure liquid state; a heating step (S420) of heating the working fluid in the high-pressure liquid state discharged in the compressing step (S410) by the high temperature unit of the thermoelectric module and the heater and discharging the heated working fluid in a high-pressure vapor state; an expanding step (S430) of expanding the working fluid in the high-pressure vapor state discharged in the heating step (S420) to generate power and discharging the working fluid in the low-pressure vapor state; a condensing step (S440) of cooling the working fluid in the low-pressure vapor state discharged in the expanding step (S430) to be condensed in a low-pressure liquid state and discharging the condensed working fluid in the low-pressure liquid state; and a generating step (S450) of converting the power generated in the expanding step (S430) into a current.

As set forth above, according to the exemplary embodiments of the present invention, it is possible to perform the indoor cooling while minimizing the energy consumption by using the heat generated during the indoor cooling using the thermoelectric module when the interior of the vehicle is cooled using the thermoelectric module and power is generated using the Rankine cycle.

Further, it is possible to precisely control the indoor temperature by controlling the current supplied to the thermoelectric module.

Further, it is possible to implement the weight reduction and save costs by more simplifying the system than the case in which the existing air conditioner system and Rankine cycle system are each applied.

Further, it is possible to increase the efficiency of the Rankine cycle condenser and the cooling capacity by removing the air conditioner system (in particular, air conditioner condenser).

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a cooling system using a Rankine cycle and a thermoelectric module according to an exemplary embodiment of the present invention.

FIG. 2 is a block diagram of a cooling system using a Rankine cycle and a thermoelectric module according to another exemplary embodiment of the present invention.

FIG. 3 is a schematic flow chart of a control method of a cooling system using a Rankine cycle and a thermoelectric module according to another exemplary embodiment of the present invention.

FIG. 4 is a flow chart of a control method of a cooling system using a Rankine cycle and a thermoelectric module according to another exemplary embodiment of the present invention.

FIG. 5 is a diagram for describing an effect of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

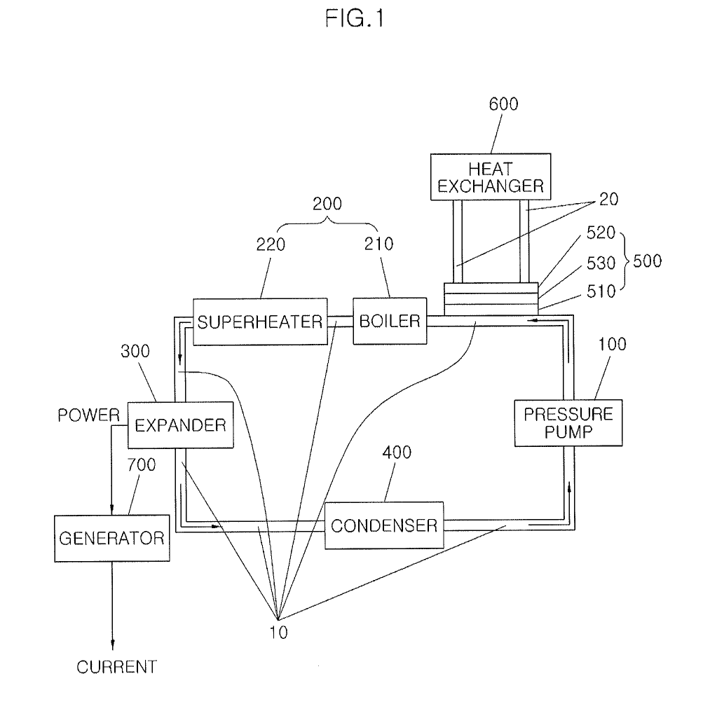

FIG. 1 is a block diagram of a cooling system using a Rankine cycle and a thermoelectric module according to an exemplary embodiment of the present invention. Referring to FIG. 1, a cooling system using a Rankine cycle and a thermoelectric module according to an exemplary embodiment of the present invention includes a pressure pump 100, a heater 200, an expander 300, a condenser 400, a thermoelectric module 500, and a heat exchanger 600. The Rankine cycle involves a phase change in vapor and liquid of a working fluid during a cycle which includes two adiabatic changes and two isobaric changes.

The pressure pump 100 sucks and compresses the working fluid inside the Rankine cycle and discharges the compressed working fluid in a high-pressure liquid state and the heater 200 heats the working fluid in the high-pressure liquid state discharged from the pressure pump 100 and discharges the heated working fluid in a high-pressure vapor state. The heater 200 includes a boiler 210 configured to use heated engine cooling water to heat the working fluid and a superheater 220 configured to use heat from engine exhaust gas to heat the working fluid. That is, the heater 200 uses waste heat (engine of an engine discharged from a radiator by the engine cooling water, heat of the high-temperature engine exhaust gas, or the like) to heat the working fluid, thereby generating electric energy as described below. Since the temperature of the engine exhaust gas is higher than that of the heated engine cooling water, the boiler 210 is preferably positioned in front of the superheater 220 based on a flow direction of the working fluid.

The expander 300 expands the working fluid in the high-pressure vapor state discharged from the heater 200 to generate power and discharges the working fluid in a low-pressure vapor state. The condenser 400 cools the working fluid in the low-pressure vapor state discharged from the expander 300 to be condensed in the low-pressure liquid state and discharges the condensed working fluid in the low-pressure liquid state.

The pressure pump 100, the heater 200, the expander 300, and the condenser 400 communicate with one another by a working fluid channel 10 through which the working fluid flows.

The thermoelectric module 500 has a high-temperature unit 510 installed on one surface thereof, a low-temperature unit 520 installed on the other surface thereof, and a semiconductor 530 embedded in a center thereof. When the thermoelectric module 500 is applied with a current, a temperature difference occurs between the high-temperature unit 510 and the low-temperature unit 520. By using the temperature difference, the interior of the vehicle is cooled and the working fluid is heated to generate power. The thermoelectric module 500 is disposed between the pressure pump 100 and the heater 200. Therefore, when the thermoelectric module 500 is applied with a current, the high-temperature unit 510 heats the working fluid in the high-pressure liquid state. That is, the high temperature unit 510 is disposed to contact an outer circumferential surface of the working fluid channel 10 through which the pressure pump 100 and heater 200 communicate with each other to transfer heat energy to the working fluid.

The heat exchanger 600 is connected to the low temperature unit 520 of the thermoelectric module 500 through a heat medium channel 20. Therefore, when the thermoelectric module 500 is applied with a current, the low temperature unit 520 cools a heat medium inside the heat medium channel 20 and introduces the cooled heat medium into the heat exchanger 600 to exchange heat with indoor air, thereby cooling the interior of the vehicle.

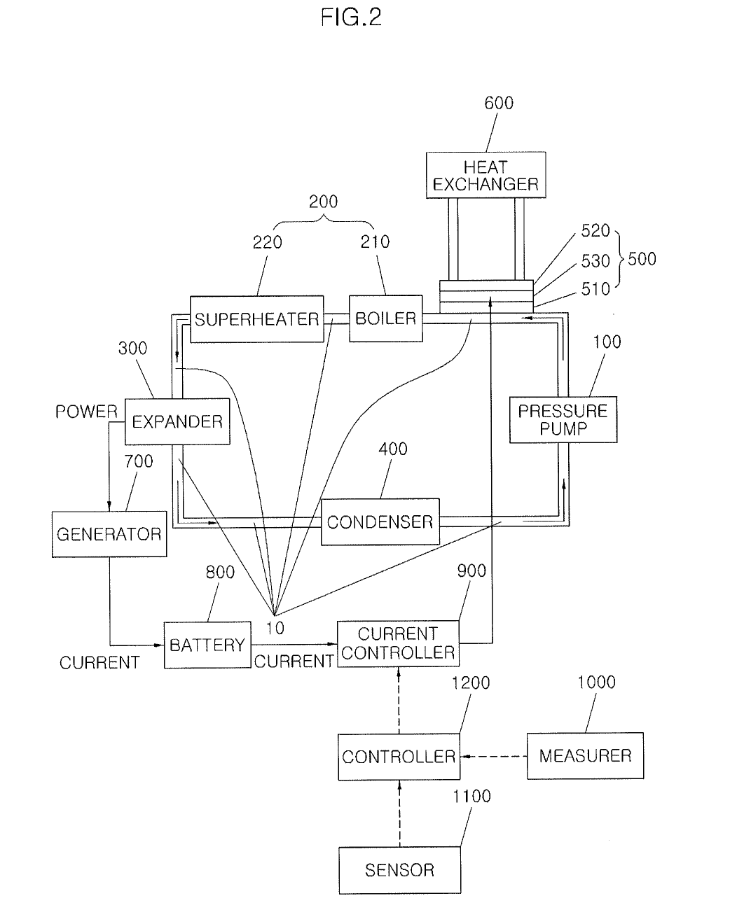

FIG. 2 is a block diagram of a cooling system using a Rankine cycle and a thermoelectric module according to another exemplary embodiment of the present invention. Referring to FIG. 2, a cooling system using a Rankine cycle and a thermoelectric module according to another exemplary embodiment of the present invention further includes a generator 700, a battery 800, a current controller 900, a measurer 1000, a sensor 1100, and a controller 1200, in addition to the pressure pump 100, the heater 200, the expander 300, the condenser 400, the thermoelectric module 500, and the heat exchanger 600 all of which are described above.

The generator 700 converts the power generated from the expander 300 into a current and the battery 800 stores a current generated from the generator 700 and supplies the current to the thermoelectric module 500.

The current controller 900 is connected to the battery 800 to control the current supplied to the thermoelectric module 500. Therefore, the current controller 900 may control the temperature of the low temperature unit 520 of the thermoelectric module 500 to control the indoor cooling performance of the heat exchanger 600 which is connected to the low temperature unit 520 of the thermoelectric module 500 through the heat medium channel 20.

The controller 1200 compares an indoor temperature measured by the measurer 1000 measuring the indoor temperature with a cooling setting temperature sensed by the sensor 1100 sensing the cooling setting temperature to control the current controller 900.

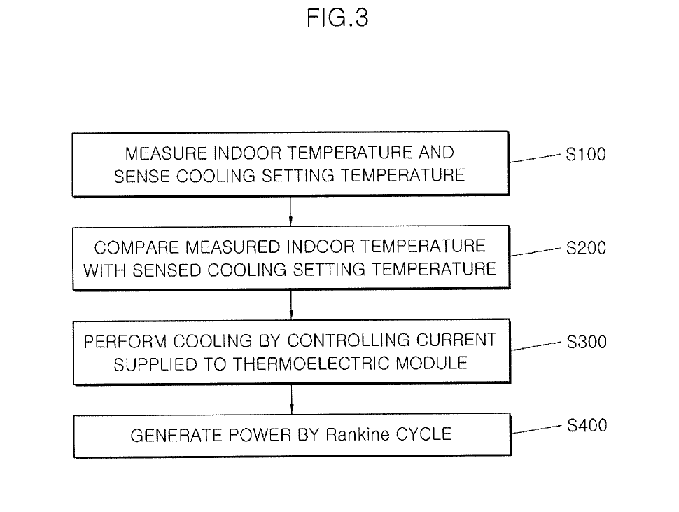

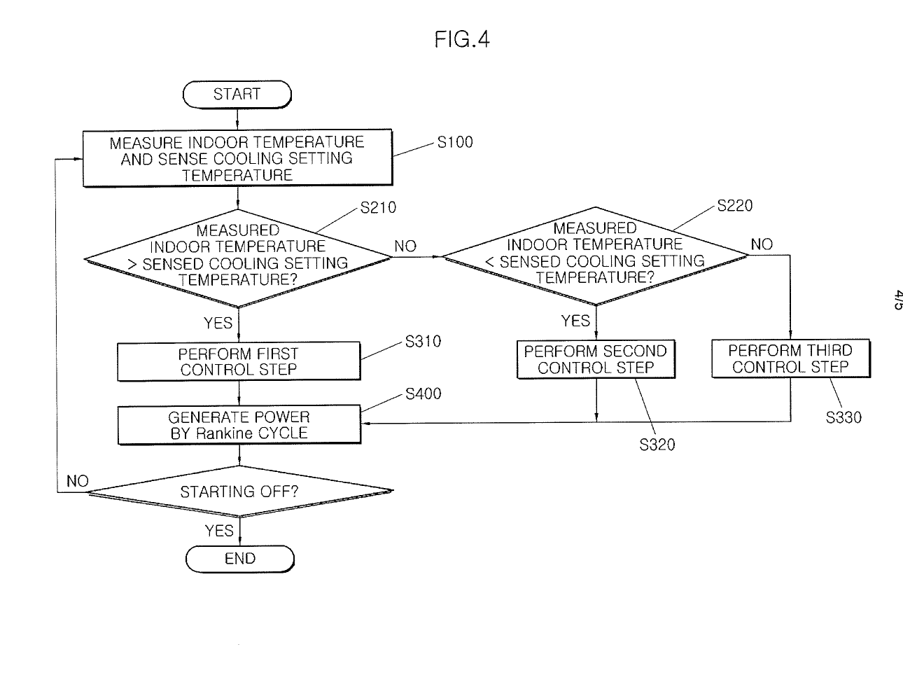

FIG. 3 is a schematic flow chart of a control method of a cooling system using a Rankine cycle and a thermoelectric module according to another exemplary embodiment of the present invention and FIG. 4 is a flow chart of a control method of a cooling system using a Rankine cycle and a thermoelectric module according to another exemplary embodiment of the present invention. Referring to FIGS. 3 and 4, a control method of a cooling system using a Rankine cycle and a thermoelectric module according to another exemplary embodiment of the present invention includes: measuring an indoor temperature and sensing a cooling setting temperature (S100), comparing the measured indoor temperature with the sensed cooling setting temperature (S200), cooling an interior by controlling a current supplied to a thermoelectric module 500 (S300), and generating the current supplied to the thermoelectric module 500 through the Rankine cycle (S400).

The comparing (S200) includes: a first determining step (S210) of determining whether the measured indoor temperature exceeds the sensed cooling setting temperature: and a second determining step (S220) of determining whether the measured indoor temperature is less than the sensed cooling setting temperature if it is determined that the measured indoor temperature does not exceed the sensed cooling setting temperature. That is, a driver compares the set cooling setting temperature with a current indoor temperature to determine whether to increase power used for the indoor cooling to reduce the indoor temperature or whether to reduce the power used for the indoor cooling to increase the indoor temperature.

The cooling (S300) include: a first cooling step (S310) of increasing the current supplied to the thermoelectric module 500 to reduce a temperature of a low temperature unit 520 of the thermoelectric module 500 if it is determined that the indoor temperature measured in the first determining step (S210) exceeds the sensed cooling setting temperature, a second cooling step (S320) of reducing the current supplied to the thermoelectric module 500 to increase the temperature of the low temperature unit 520 of the thermoelectric module 500 if it is determined that the indoor temperature measured in the second determining step (S220) is less than the sensed cooling setting temperature, and a third cooling step (S330) of keeping the current supplied to the thermoelectric module 500 to keep the temperature of the low temperature unit 520 of the thermoelectric module 500 if it is determined that the indoor temperature measured in the second determining step (S220) is not less than the sensed cooling setting temperature.

That is, if it is determined that the measured indoor temperature exceeds the sensed cooling setting temperature, since there is a need to reduce the indoor temperature, the current supplied to the thermoelectric module 500 needs to be increased. Therefore, the temperature of the low temperature unit 520 of the thermoelectric module 500 is reduced and the temperature of the heat medium inside the heat medium channel connected to the low temperature unit 520 is also reduced, and therefore the heat exchanger 600 may use the low-temperature heat medium to more reduce the indoor temperature. At the same time, the temperature of the high temperature unit 510 of the thermoelectric module 500 is increased and therefore the heat energy of the high temperature unit 510 may be used to heat the working fluid of the Rankine cycle. Therefore, the power generated by the Rankine cycle may be increased, and therefore the indoor cooling may be performed while the energy consumption is minimized.

Further, if it is determined that the measured indoor temperature is less than the sensed cooling setting temperature, since there is no longer need to reduce the indoor temperature, the current supplied to the thermoelectric module 500 needs to be reduced. Therefore, the temperature of the low temperature unit 520 of the thermoelectric module 500 is increased and the temperature of the heat medium inside the heat medium channel connected to the low temperature unit 520 is also increased, and therefore the heat exchanger 600 may no longer reduce the indoor temperature by the relatively high-temperature heat medium.

Further, when the measured indoor temperature is equal to the sensed cooling setting temperature, to keep the current indoor temperature, the current supplied to the thermoelectric module 500 is kept.

The generating (S400) includes: a compressing step (S410) of sucking and compressing a working fluid inside the Rankine cycle by a pressure pump 100 and discharging the compressed working fluid in a high-pressure liquid state, a heating step (S420) of heating the working fluid in the high-pressure liquid state discharged in the compressing step (S410) by the high temperature unit 510 of the thermoelectric module 500 and the heater 200 and discharging the heated working fluid in a high-pressure vapor state, an expanding step (S430) of expanding the working fluid in the high-pressure vapor state discharged in the heating step (S420) to generate power and discharging the working fluid in the low-pressure vapor state, a condensing step (S440) of cooling the working fluid in the low-pressure vapor state discharged in the expanding step (S430) to be condensed in a low-pressure liquid state and discharging the condensed working fluid in the low-pressure liquid state, and a generating step (S450) of converting the power generated in the expanding step (S430) into a current.

That is, power is generated in the expanding step (S430), in the Rankine cycle which includes the compressing step (S410), the heating step (S420), the expanding step (S430), and the condensing step (S440). Further, in the generating step (S450), a current is generated using the generated power.

The generated current may be directly supplied to the thermoelectric module 500 or may be supplied to the thermoelectric module 500 through the battery 800. The cooling (S300) in which the cooling is performed by the current supplied to the thermoelectric module 500 is performed.

In the cooling (S300), when a current is supplied to the thermoelectric module 500, the temperature of the high temperature unit 510 is increased while the temperature of the low temperature unit 520 is reduced. According to the exemplary embodiment of the present invention, the generated heat energy of the high temperature unit 510 is not discharged as waste heat but is used to heat the working fluid in the heating step (S420) of the Rankine cycle. Therefore, the exemplary embodiment of the present invention may secure energy efficiency much higher than that of the existing thermoelectric cooling system.

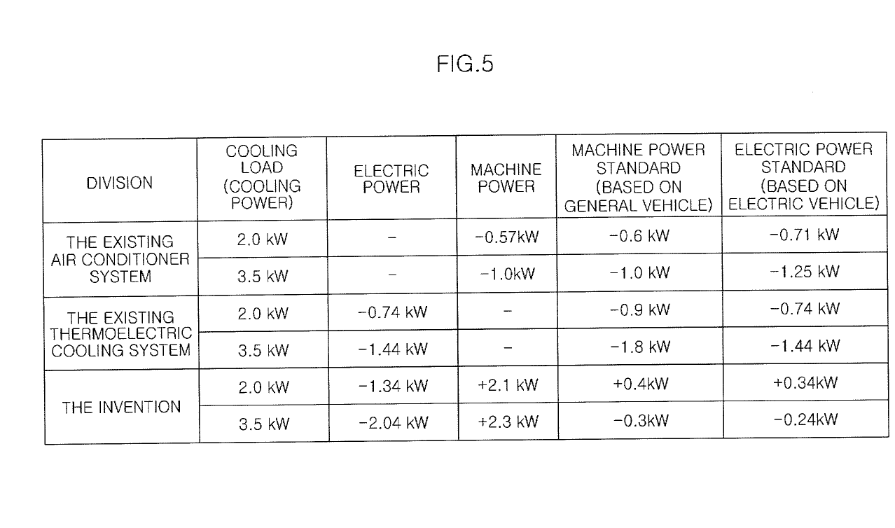

FIG. 5 is a diagram for describing an effect of the present invention. Referring to FIG. 5, Rankine cycle efficiency was set to be 12%, expander efficiency was set to be 80%, a coefficient of performance (COP) of the existing air conditioner system was set to be 3.5, a COP of the thermoelectric cooling system was set to be 2.7, and efficiency at the time of electricity-machine power conversion was set to be 80%. The case in which the heat energy which may be supplied from the outside in addition to the cooling load is set to be 20 kW and the cooling load is set to be 2.0 kW and 3.5 kW was considered. It may be appreciated from referring to FIG. 5 that in the general vehicle in which the cooling load in the existing air conditioner system is 2.0 kW, the machine power (engine power) for driving the compressor, etc., is consumed as much as about 0.6 kW and in the electric vehicle, the electric power for driving the compressor, and the like is consumed as much as about 0.71 kW. Further, it may be appreciated that in the general vehicle in which the cooling load in the existing air conditioner system is 3.5 kW, the machine power (engine power) for driving the compressor, etc., is consumed as much as about 1.0 kW and in the electric vehicle, the electric power for driving the compressor, and the like is consumed as much as about 1.25 kW.

It may be appreciated from FIG. 5 that in the electric vehicle in which the cooling load in the existing cooling system using only the thermoelectric module is 2.0 kW, the electric power for driving the compressor, and the like is consumed as much as about 0.74 kW and in the general vehicle, the machine power (engine power) is consumed as much as about 0.9 kW. Further, it may be appreciated that in the electric vehicle in which the cooling load in the existing cooling system using only the thermoelectric module is 3.5 kW, the electric power is consumed as much as about 1.44 kW and in the general vehicle, the machine power (engine power) for driving the compressor, and the like is consumed as much as about 1.8 kW.

In connection with this, when the cooling load in the vehicle to which the present invention is applied is 2.0 kW, the electric power for cooling is consumed but power is generated by the Rankine cycle, and therefore in the case of the general vehicle, power of about 0.4 kW is generated and in the case of the electric vehicle, power of about 0.34 kW is generated. Further, when the cooling load in the vehicle to which the present invention is applied is 3.5 kW, the electric power for cooling is consumed but machine power is generated by the Rankine cycle, and therefore in the case of the general vehicle, power of about 0.3 kW is consumed and in the case of the electric vehicle, power of about 0.24 kW is consumed.

That is, compared with the existing air conditioner system and cooling system using only a thermoelectric module, the cooling system using a Rankine cycle and a thermoelectric module according to the exemplary embodiment of the present invention may use the thermoelectric module to cool the interior of the vehicle and use the heat generated during the indoor cooling using the thermoelectric module at the time of generating the power using the Rankine cycle, thereby performing the indoor cooling while minimizing the energy consumption.

The foregoing exemplary embodiments are only examples to allow a person having ordinary skill in the art to which the present invention pertains (hereinafter, referred to as those skilled in the art) to easily practice the present invention. Accordingly, the present invention is not limited to the foregoing exemplary embodiments and the accompanying drawings, and therefore, a scope of the present invention is not limited to the foregoing exemplary embodiments. Accordingly, it will be apparent to those skilled in the art that substitutions, modifications and variations can be made without departing from the spirit and scope of the invention as defined by the appended claims and can also belong to the scope of the invention.

What is claimed is:

1. A cooling system using a Rankine cycle and a thermoelectric module, comprising:
a pressure pump configured to suck and compress a working fluid inside the Rankine cycle and discharge the compressed working fluid in a high-pressure liquid state;
a heater configured to heat the working fluid in the high-pressure liquid state discharged from the pressure pump and discharge the heated working fluid in a high-pressure vapor state;
an expander configured to expand the working fluid in the high-pressure vapor state discharged from the heater to generate power and discharge the working fluid in a low-pressure vapor state;
a condenser configured to cool the working fluid in the low-pressure vapor state discharged from the expander to be condensed in the low-pressure liquid state and discharge the condensed working fluid in the low-pressure liquid state; and
a thermoelectric module including a high-temperature unit installed on a first surface thereof, a low-temperature unit installed on a second surface thereof, and a semiconductor embedded in a center thereof.

2. The cooling system of claim 1, wherein the thermoelectric module is disposed between the pressure pump and the heater to heat the working fluid in the high-pressure liquid state using the high-temperature unit when being applied with a current.

3. The cooling system of claim 1, wherein the heater includes:
a boiler configured to use heated engine cooling water to heat the working fluid; and
a superheater configured to use heat from engine exhaust gas to heat the working fluid.

4. The cooling system of claim 1, further comprising:
a heat exchanger connected to the low temperature unit of the thermoelectric module through a heat medium channel.

5. The cooling system of claim 1, further comprising:
a generator configured to convert power generated from the expander into a current.

6. The cooling system of claim 5, further comprising:
a battery configured to store a current generated from the generator and supply the current to the thermoelectric module.

7. The cooling system of claim 6, further comprising:
a current controller connected to the battery to control the current supplied to the thermoelectric module.

8. The cooling system of claim 7, further comprising:
a controller configured to compare an indoor temperature measured by a measurer measuring the indoor temperature with a cooling setting temperature sensed by a sensor sensing the cooling setting temperature to control the current controller.

9. A control method of a cooling system using a Rankine cycle and a thermoelectric module, comprising:
measuring an indoor temperature and sensing a cooling setting temperature;
comparing the measured indoor temperature with the sensed cooling setting temperature;
cooling an interior by controlling a current supplied to a thermoelectric module; and
generating the current supplied to the thermoelectric module through the Rankine cycle.

10. The control method of claim 9, wherein the comparing includes a first determining step of determining whether the measured indoor temperature exceeds the sensed cooling setting temperature.

11. The control method of claim 10, wherein the cooling includes a first cooling step of increasing the current supplied to the thermoelectric module to reduce a temperature of a low temperature unit of the thermoelectric module when the indoor temperature measured in the first determining step is determined to exceed the sensed cooling setting temperature.

12. The control method of claim 9, wherein the comparing includes a second determining step of determining whether the measured indoor temperature is less than the sensed cooling setting temperature when the measured indoor temperature is determined to not exceed the sensed cooling setting temperature.

13. The control method of claim 12, wherein the cooling includes a second cooling step (S320) of reducing the current supplied to the thermoelectric module to increase the temperature of the low temperature unit of the thermoelectric module when the indoor temperature measured in the second determining step is determined to be less than the sensed cooling setting temperature.

14. The control method of claim 12, wherein the cooling includes a third cooling step of keeping the current supplied to the thermoelectric module to keep the temperature of the low temperature unit of the thermoelectric module when the indoor temperature measured in the second determining step is determined to be not less than the sensed cooling setting temperature.

15. The control method of claim 9, wherein the generating includes a compressing step of sucking and compressing a working fluid inside the Rankine cycle by a pressure pump and discharging the compressed working fluid in a high-pressure liquid state.

16. The control method of claim 15, wherein the generating includes a heating step of heating the working fluid in the high-pressure liquid state discharged in the compressing step by the high temperature unit of the thermoelectric module and the heater and discharging the heated working fluid in a high-pressure vapor state.

17. The control method of claim 16, wherein the generating includes an expanding step of expanding the working fluid in the high-pressure vapor state discharged in the heating step to generate power and discharging the working fluid in the low-pressure vapor state.

18. The control method of claim 17, wherein the generating includes a condensing step of cooling the working fluid in the low-pressure vapor state discharged in the expanding step to be condensed in a low-pressure liquid state and discharging the condensed working fluid in the low-pressure liquid state.

19. The control method of claim 17, wherein the generating includes a generating step of converting the power generated in the expanding step into a current.
